(19) United States
(12) Patent Application Publication
(10) Pub. No.: US 2024/0170690 A1
(43) Pub. Date: May 23, 2024

(54) SEPARATOR PLATE FOR AN ELECTROCHEMICAL SYSTEM, HAVING A LOAD RELIEF BEAD

(71) Applicant: Reinz-Dichtungs-GmbH, Neu-Ulm (DE)

(72) Inventors: André SPEIDEL, Bussmanshausen (DE); Bernd GAUGLER, Ulm (DE)

(21) Appl. No.: 18/515,056

(22) Filed: Nov. 20, 2023

(30) Foreign Application Priority Data
Nov. 21, 2022 (DE) 20 2022 106 505.5

(51) Int. Cl. H01M 8/0247; C25B 13/02; H01M 8/0276

(52) U.S. Cl. CPC H01M 8/0247; C25B 13/02; H01M 8/0276

(57) ABSTRACT

A separator plate for an electrochemical system and a bipolar plate comprising two such separator plates for an electrochemical system. An electrochemical system comprising at least two separator plates and/or one bipolar plate. A separator plate comprising: at least one sealing bead for sealing off a region of the separator plate and at least one load relief bead which relieves load on the sealing bead, the load relief bead arranged spaced apart from the sealing bead, and, in a cross-section perpendicular to the course of the load relief bead, at least in a non-compressed state of the separator plate, at least one bead flank of the load relief bead comprises, in at least a first segment along the direction of extension, at least a first, outer portion and a second, inner portion which are at different positive angles to the separator plate plane.

### CROSS-REFERENCE TO RELATED APPLICATION

The present application claims priority to German Utility Model Application No. 20 2022 106 505.5, entitled “SEPARATOR PLATE FOR AN ELECTROCHEMICAL SYSTEM, HAVING A LOAD RELIEF BEAD”, and filed Nov. 21, 2022. The entire contents of the above-listed application is hereby incorporated by reference for all purposes.

### TECHNICAL FIELD

The present disclosure relates to a separator plate for an electrochemical system and to a bipolar plate comprising two such separator plates for an electrochemical system. The present disclosure further relates to an electrochemical system comprising at least two separator plates and/or one bipolar plate. The electrochemical system may be a fuel cell system, an electrochemical compressor, a redox flow battery, or an electrolyser.

### BACKGROUND AND SUMMARY

Known electrochemical systems usually comprise a stack of electrochemical cells which are separated from each other by bipolar plates. Dimensionally stable and structurally rigid end plates are usually arranged at both ends of the stack. Such bipolar plates may serve, for example, for indirectly electrically contacting the electrodes of the individual electrochemical cells (for example fuel cells) and/or for electrically connecting adjacent cells (series connection of the cells). The bipolar plates are typically formed of two individual plates which are joined together, these being referred to hereinafter as separator plates. The separator plates of the bipolar plate may be joined together in a materially bonded manner, for example by one or more welded joints, for example by one or more laser-welded joints. While bipolar plates composed of two separator plates are almost always used in fuel cell systems, it is possible for both two-layer bipolar plates and single-layer separator plates to be used instead of bipolar plates in the other electrochemical systems mentioned.

The electrochemical cells typically also include in each case one or more membrane electrode assemblies (MEAs). In addition to the actual membranes and the catalyst layers and electrodes, the MEAs may each have one or more gas diffusion layers, which are usually oriented towards the bipolar plates and are formed, for example, as a metal or carbon fleece.

The bipolar plates or the individual separator plates may each have or form structures which are designed, for example, to supply one or more reaction media to the electrochemical cells bounded by adjacent bipolar plates and/or to convey reaction products away therefrom. The media may be fuels (for example hydrogen or methanol) or reaction gases (for example air or oxygen). The bipolar plates or the separator plates may also have structures for guiding a cooling medium through the bipolar plate, such as through a cavity enclosed by the separator plates of the bipolar plate. The bipolar plates may additionally be designed to transfer the waste heat generated during the conversion of electrical or chemical energy in the electrochemical cell and to seal off the different media channels and/or cooling channels with respect to each other and/or with respect to the outside. The reaction media, reaction products and the fresh or heated cooling medium can be grouped together under the term “media”.

Furthermore, the bipolar plates or the individual separator plates usually each have a plurality of through-openings. Through the through-openings, the media can be routed in the stacking direction towards the electrochemical cells bounded by adjacent separator plates of the stack or into the cavity formed by the separator plates of the bipolar plate, or can be routed out of the cells or out of the cavity. Furthermore, the separator plates may also have channel structures for supplying one or more media to an active region of the electrochemical cell and/or for conveying media away therefrom. To this end, for each medium, at least two through-openings—at least one inlet opening and at least one outlet opening—can be fluidically connected to each other via a distribution region, a flow region and a collection region. The flow region may be located opposite the electrochemically active region of the cell. The distribution region, flow region and collection region may each have channel structures for guiding media.

The sealing between the bipolar plates and the membrane electrode assembly or between a separator plate and a membrane electrode assembly usually takes place by way of sealing elements arranged outside of the electrochemically active region and usually comprises both at least one port seal, which is arranged around a through-opening, and an outer seal (perimeter sealing element), wherein the sealing elements may be designed as bead arrangements.

In order for the sealing elements to be able to achieve a consistently good sealing effect regardless of the respectively prevailing operating state, the sealing elements may be elastically deformable, e.g. reversibly deformable, at least within a specified tolerance range. However, if the sealing elements are deformed beyond the tolerance range, plastic deformations, e.g. irreversible deformations, of the sealing elements may occur. This may lead to the sealing elements no longer being able to fulfil their sealing effect. This can significantly reduce the efficiency of the system or even make it completely impossible to maintain operation of the system. If the system is operated with highly flammable media, such as hydrogen for example, or if such media are produced during operation, damage to the sealing elements may even pose a major safety risk. Irreversible deformation of the sealing elements of the bipolar plates or separator plates may be caused, for example, as a result of significant mechanical forces suddenly acting on the plate stack, as may occur in the event of a car crash for example.

When such an electrochemical cell is subjected to a force impact, for example due to a collision, the sealing elements may sometimes undergo considerable deformations. Due to the inertia of the components and of the media guided therein, for instance the coolant, during the collision, an excessive force occurs on the sealing elements of the bipolar plates or separator plates in the direction of impact. This force may lead to permanent deformation of the sealing elements. During the actual collision, the forces may act strongly on the sealing elements of the separator plates that are located at a short distance from the force application point and are thus arranged closer to the end plate referred to as the first end plate. As the distance of the separator plates increases, the force acting on the sealing elements during the collision decreases. As the stack subsequently “rebounds”, the sealing elements of the unloaded separator plates on the side remote from the impact are abruptly compressed as a result of striking against the second end plate, the forces here being greater as the distance of the separator plates from the site of impact increases. Both phenomena, which are comparable to a shock wave, may lead to a loss of sealing of the stack as a whole and may thus render it unusable.

The electrochemical system or the separator plates thereof may be provided with a load relief mechanism which, to the greatest extent possible, protects the sealing elements against irreversible plastic deformations, even under the effect of significant mechanical forces.

One known solution provides for enclosing the electrochemical system in a protective container which has a high strength and good mechanical stability. However, in the event of an impact, an impulse transfer may occur which is so large that it cannot be absorbed and/or eliminated by the protective container; it is therefore transmitted to the plate stack in substantially unattenuated form. Furthermore, such a protective container is usually associated with additional costs, weight, installation space requirements and outlay on material, which are often undesirable, especially for mobile applications.

Other known solutions provide electronic switch-off mechanisms, but these merely interrupt flows of media and do not provide any protection against mechanical destruction.

It would therefore be desirable if an assembly could be created that can withstand the greatest possible mechanical loads and thus ensures the safest possible operation. The installation space requirement and the weight of the assembly sought should increase as little as possible or barely at all compared to the known solutions.

WO 2019/076813 A1 proposes pad-like shock absorbers for absorbing the impact energy, which are applied in the border region of the bipolar plate, for example by being placed or plugged thereon or adhesively bonded thereto. The application of these shock absorbers is therefore associated with additional effort and often with at least one additional manufacturing step. The same applies to pressure absorbers applied by printing or in the form of a film, such as those disclosed in US 2020/0388858. It would be desirable if production of the separator plate could be simplified.

The object of the present disclosure is therefore to develop a more robust separator plate, or a bipolar plate or an electrochemical cell comprising at least one separator plate, which at least partially solves the problems mentioned above.

The object is achieved by the subjects of the independent claims.

A separator plate according to the present disclosure for an electrochemical system comprises at least one sealing bead for sealing off a region of the separator plate, and at least one load relief bead for relieving the load on the sealing bead, which load relief bead may relieve the load on the at least one sealing bead in the working range and also in a crash situation or in the event of an impact. The at least one sealing bead and the at least one load relief bead are spaced apart from each other and may each rise out of the separator plate plane in the same direction.

In a cross-section perpendicular to the course of the load relief bead in a non-compressed state of the separator plate, the at least one load relief bead has, in at least a first segment along its direction of extension, e.g. perpendicular to its direction of extension, at least one bead flank having at least a first, outer portion and a second, inner portion. The first, outer portion and the second, inner portion of the bead flank are at different positive angles to the separator plate plane.

A non-compressed state of the separator plate will be understood to mean, for instance, a state in which the separator plate rests on a surface without any deliberate application of force. The non-compressed state of the separator plate also includes a state in which the separator plate is connected to another separator plate to form a bipolar plate and this bipolar plate rests on a surface in a comparable manner. The term “non-compressed state” also includes the situation in which the bipolar plates may be stacked, for example in a manner alternating with the membrane electrode assemblies, without any external compression; in all three cases, the forces resulting from the intrinsic weight of the separator plate or bipolar plate and, where present, the MEA are disregarded.

In contrast, a compressed state will be understood to mean a state in which the bipolar plates with their separator plates are stacked in a manner alternating with membrane electrode assemblies to form a stack and are clamped between the end plates of the bipolar plate stack, optionally with the interposition of further components. The clamping takes place in such a way that the sealing beads are predominantly elastically compressed. The electrochemical system is therefore in the compressed state in the working range of the sealing bead.

However, if the electrochemical system and thus also the bipolar plates and the separator plates are compressed further, an overcompressed state occurs. These are therefore states that occur during or after an impact. The present disclosure also serves to enable the sealing bead to spring back into its working range after such an impact, so that the electrochemical system is still sealed and viable, possibly with limitations, after such an impact.

Both the at least one sealing bead and the at least one load relief bead may be designed at least approximately as full beads, each having two bead flanks and a bead top extending between these bead flanks. A bead top may be curved away from the separator plate plane or may extend substantially rectilinearly, for instance parallel to the separator plate plane. In the case of a full bead with a curved bead top, a maximum of 20%, and/or a maximum of 15% of the total bead height can be accounted for by the height of this curvature. The bead flanks of the at least one load relief bead and/or of the at least one sealing bead may be mirror-symmetrical to each other in a cross-section perpendicular to the direction of extension thereof, wherein the plane of symmetry may extend perpendicular to the separator plate plane. However, asymmetrical bead shapes having differently designed bead flanks are also possible.

For instance, in the non-compressed state of the separator plate, the bead top of the load relief bead projects equally as far or less far out of the separator plate plane than the bead top of the sealing bead. When the stack is pressed together between the end plates prior to being put into operation, usually first the bead top of the sealing bead comes to bear against the MEA. The load relief bead may come to bear against the MEA just before clamping corresponding to the normal operating state is reached, or at the time this state is reached. In the compressed state of the separator plate, e.g. in the normal operating state, the load relief bead typically projects equally as far out of the separator plate plane as the sealing bead. Therefore, both the sealing bead and the load relief bead bear against the MEA in the clamped state of the separator plate. In this case, the bead tops may bear with a sheet metal surface against the MEA if both or at least one of the bead tops is uncoated, or may bear with a coating against the MEA if both or at least one of the bead tops is coated.

The first angle α of the first, outer portion of at least one bead flank of the load relief bead may be smaller than the second angle β of the adjacent second, inner portion of the same bead flank of the load relief bead. This may apply in the non-compressed state but may also apply in the compressed state of the separator plate and thus of the load relief bead.

These different flank angles have the result that, when little force is being applied to the bead top of the load relief bead, as occurs for example in the normal operating state, substantially only the first, outer portion is deformed, while the second, inner portion only undergoes a linear displacement. When stronger compression occurs, the first, outer portion may be deformed down to a plane parallel to the separator plate plane, wherein the first, outer portion may then extend substantially in this parallel plane or may accumulate in a wavy manner around this plane, depending on the possibility for lateral expansion.

For example, the flank angle of the first outer portion in the non-compressed state may be 3°-30°, 4°-20°, or 4°-10°, while the flank angle of the second inner portion in the non-compressed state may be between 45° and 85°, between 60° and 80° or between 70° and 80°.

It may be provided that, in the compressed state of the separator plate, at least one bead flank of the sealing bead is at a smaller angle to the separator plate plane than the second, inner portion of the bead flank of the load relief bead. The at least one sealing bead may be designed in such a way that, in a cross-section perpendicular to the bead course at least in the non-compressed state of the separator plate, one of its flanks has, or both of its flanks have, at least a third portion which is at a third positive angle φ to the separator plate plane, wherein this third angle φ is different from the first angle α and/or from the second angle β of the flank of the load relief bead. The first angle α may be smaller than the third angle φ in the compressed and/or non-compressed state of the separator plate. As a result, the first portion of the load relief bead is softer than the third portion, so that the spring behaviour of the system as a whole when both the sealing bead and the load relief bead are bearing against the MEA substantially corresponds to the spring behaviour when only the sealing bead is bearing against the MEA.

During the transition from the compressed state to an overcompressed state, as well as in the overcompressed state of the separator plate itself, this angle φ may be reduced by the compression to such an extent that it is smaller than the angle β of the second, inner portion of the bead flank of the load relief bead. This makes it possible to ensure that, in the event of an impact, the impact energy is absorbed almost exclusively by the load relief bead, since this can be stiffer than the sealing bead on account of this angular ratio.

The first portion and/or the second portion of the at least one flank of the at least one load relief bead and/or the third portion of the at least one flank of the at least one sealing bead may extend in a rectilinear or curved manner in cross-section. For instance, the first portion of the at least one flank of the at least one load relief bead may extend from a bead foot towards the bead top, e.g. towards the second portion, at an increasing angle α, for instance in cross-section may extend in a curved manner with a radius R1, where 0.5 mm≤R1, 2 mm≤R1, and/or R1≤70 mm, R1≤ 50 mm, applies for the radius R1.

Such a curvature of the first portion enables this portion to roll smoothly during the elastic compression of the load relief bead.

The flank sections, e.g. the first portion and the second portion, and/or the bead top can each be understood in cross-section as essentially straight line segments, which are connected to each other, possibly via curved connecting portions. In this case, the first angle and the second angle can be substantially constant.

The first portion and the second portion of the bead flank can together form a region of the load relief bead which is convex in shape in relation to the separator plate plane. The second portion and the bead top can together form a region of the load relief bead which is concave in relation to the separator plate plane.

The at least two flank portions may take up a considerable proportion of the width of the entire load relief bead. For example, the entire flank, e.g. the first, outer portion and the second, inner portion together, can have a width that is more than 50%, more than 60%, more than 70% and/or more than 80% of the width of the bead top. Summed over both bead flanks, their proportion of the total bead width is often more than half. For example, the bead top can act as a bearing area, usually a planar bearing area. If the width proportions of the at least two flank portions are considered separately, the width of the first, outer portion can be at least ⅓, at least 40%, and/or at least 50% of the width of the bead top. The proportion of the width attributable to the second, inner portion can be somewhat smaller; its width can be at least 20%, at least 25% and/or at least 30% of the width of the beaded top.

The sealing bead may be designed as a port bead for sealing off a through-opening formed in the separator plate, such as with respect to other media spaces, or as a perimeter bead for sealing off a flow field and possibly through-openings, such as with respect to the environment surrounding the separator plate.

A sealing bead, for example a port bead, may have structures for the passage of media at least in some portions. In this regard, reference is made to DE 102 48 531 A1, DE 20 2015 104 972, DE 20 2015 104 973 and the as yet unpublished DE 20 2022 101 861.8, the content of each of said documents being fully incorporated by way of reference in the present specification. In contrast, a load relief bead may not have any such passage structure.

The at least one load relief bead may be arranged between an outer edge, which delimits an outer circumference of the separator plate, and the sealing bead, for instance in a corner region or border region of the separator plate. As an alternative or in addition, the at least one load relief bead may be arranged adjacent to a port bead, such as between two port beads or between a perimeter bead and a port bead. The load relief bead may in this case extend at a distance from and alongside the sealing bead. The sealing bead may not have any of the above-mentioned passage structures in the regions adjacent to the load relief bead.

The load on the at least one sealing bead may be relieved well if the separator plate has a plurality of consecutive, spaced-apart load relief beads which are arranged along the course of the sealing bead, such as along the perimeter bead.

A load relief bead may be arranged on both sides of the at least one sealing bead, just as a sealing bead may extend on both sides of a load relief bead. For example, a load relief bead may be arranged between two port beads and can thus relieve the load on both sealing beads.

If the at least one load relief bead and the at least one sealing bead extend at least in part in a substantially parallel manner, then, for instance or exclusively in one, some or all of the portions that have a substantially parallel course, the mutually facing bead flanks of the sealing bead and the load relief bead are at different positive angles to the separator plate plane in a cross-section perpendicular to the bead course. Furthermore, if, in a region between the sealing bead and the load relief bead, the separator plate may extend in a substantially planar manner and parallel to the separator plate plane and/or has no embossed structures.

As an alternative or in addition, the at least one load relief bead may be arranged in a distribution region or in a collection region. Here, too, a plurality of load relief beads may be arranged spaced apart from each other, for example one next to the other, one behind the other, or in a manner offset from each other. For instance, the direction of extension of a load relief bead may be arranged in a distribution region or a collection region deviates by no more than ±30°, no more than ±15°, and/or no more than ±5°, from the direction of flow of the fluid or the direction of extension of the fluid channels on the surface in question and may extend parallel thereto. In this arrangement, further structures may be provided in a region between the sealing bead and the load relief bead.

Both at least one sealing bead and at least one load relief bead may extend at least in part in a rectilinear manner and/or in a wavy manner with at least one wave period in its direction of extension. At least one rectilinear portion of the at least one sealing bead may extend along a rectilinear portion of the at least one load relief bead, a wavy portion of the at least one sealing bead may extend along a wavy portion of the at least one load relief bead either in phase or out of phase therewith, such as by λ/2, or a rectilinear portion of the sealing bead/load relief bead may extend along a wavy portion of the load relief bead/sealing bead.

By virtue of the separator plate described above, a substantially elastic compression both of the sealing bead and of the load relief bead takes place in the compressed state, and therefore in the working range the load relief bead does not lead to any significant change in the spring behaviour of the sealing bead. On the other hand, during the transition from the compressed to the overcompressed state, the excessive forces that may occur in the event of an impact, for example, may be predominantly introduced into the load relief bead, so that the sealing bead only has to absorb a small portion of the energy of the impact. Since the load relief bead, or more precisely the second, inner flank portion thereof, forms the least flexible structure of the separator plate in the overcompressed state, in a crash situation the load relief bead can absorb additional force which in the absence of the load relief bead would have to be absorbed by the sealing bead, thereby relieving the load on the sealing bead and thus reducing the likelihood of permanent deformation of the sealing bead.

To locally adjust the spring behaviour of the load relief bead, the bead top of the load relief bead may for example be provided with depressions. These depressions may be spot-shaped or may extend at least in part in the longitudinal direction of the load relief bead. The depressions may also be arranged in groups and/or in a chain-like manner and may be configured differently, such as with different depths, or identically within a group/chain.

The separator plate may be formed from a sheet, such as a metal sheet, such as a stainless-steel sheet, optionally with a coating. The at least one sealing bead and the at least one load relief bead of the separator plate may be integrally formed in the respective separator plate, for example by means of hydroforming, embossing and/or deep-drawing. In this specification, the term embossing will be used as representative of hydroforming, embossing—roller embossing or vertical embossing—and deep-drawing. The separator plate plane of the separator plate may be a plane spanned by three points from undeformed regions of the separator plate. These three points are typically located in bearing areas of the undeformed regions of the separator plate, at which the latter adjoins the next separator plate in the assembled state, e.g. typically on the side facing away from the MEA in the case of a fuel cell. Undeformed regions of the separator plate may be regions of the separator plate that have no embossed structures. The separator plate has a thickness that is usually at least 50 μm and/or at most 200 μm. The thickness is therefore the extent of the sheet of the separator plate perpendicular to the separator plate plane and may in some cases be disregarded compared to the other dimensions of the separator plate.

The present disclosure also relates to a bipolar plate comprising two separator plates as described above, which are connected to each other and are arranged in such a way that the undersides thereof face towards each other and the sealing beads and load relief beads of the two separator plates point with their bead tops away from each other.

The two separator plates of the bipolar plate may at least in part be connected to each other by means of welded joints, for example by means of laser-welded joints, for example on both sides of the load relief bead and/or between the load relief bead and the sealing bead and/or on both sides of the sealing bead. The welded joints may be spot welds, stitch welds or linear welds, or may possibly even be configured in the form of interlocking arcs. They may consist of spaced-apart welds or continuous or compound welds and therefore may be fluid-tight. For instance, sealing welded joints on one side of a bead may be combined with non-sealing welded joints on the other side of this bead.

The present disclosure also encompasses an electrochemical system comprising a plurality of separator plates as described above and/or a plurality of bipolar plates as described above. Depending on the application, electrochemical cells are arranged between the separator plates (for example in the case of electrolysers) or between the bipolar plates (for example in the case of fuel cells). The electrochemical cells and the separator plates or bipolar plates are in this case stacked in a stack perpendicular to the separator plate planes and are pressed together between end plates, optionally with the interposition of further components.

The further embodiments of the electrochemical system and of the bipolar plates largely correspond to the further embodiments described for the separator plates.

Exemplary embodiments of the separator plate, of the bipolar plate, of the assembly, of the electrochemical cell and of the electrochemical system are shown in the accompanying figures and will be explained in greater detail on the basis of the following description.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 schematically shows, in a perspective view, an electrochemical system comprising a plurality of separator plates or bipolar plates arranged in a stack.

FIG. 2 schematically shows, in a perspective view, two bipolar plates of the system according to FIG. 1, each consisting of two separator plates, with a membrane electrode assembly (MEA) arranged between the bipolar plates.

FIG. 3 schematically shows a plan view of part of a separator plate or bipolar plate in a first variation of the present disclosure.

FIG. 4 shows, in three sub-FIGS. 4A to 4C, schematic sectional views of the bipolar plate of FIG. 3, consisting of two separator plates, along the section line A-A in three states of compression.

FIG. 5 shows, in four sub-FIGS. 5A to 5D, schematic sectional views of the bipolar plate of FIG. 3, consisting of two separator plates, along the section line B-B in four states of compression.

FIG. 6 shows, in three sub-FIGS. 6A to 6C, schematic sectional views of the bipolar plate of FIG. 3, consisting of two separator plates, along the section line C-C in three states of compression and in sub-FIG. 6D an alternative variant to sub-FIG. 6A.

FIG. 7 schematically shows a plan view of a bipolar plate, consisting of two separator plates, in a further variation.

FIG. 8 schematically shows a plan view of a bipolar plate, consisting of two separator plates, in a further variation.

FIG. 9 schematically shows a plan view of a bipolar plate, consisting of two separator plates, in a further variation.

### DETAILED DESCRIPTION

Here and below, features that recur in different figures are denoted in each case by the same or similar reference signs. For the sake of clarity, the repetition of reference signs in the figures is sometimes omitted.

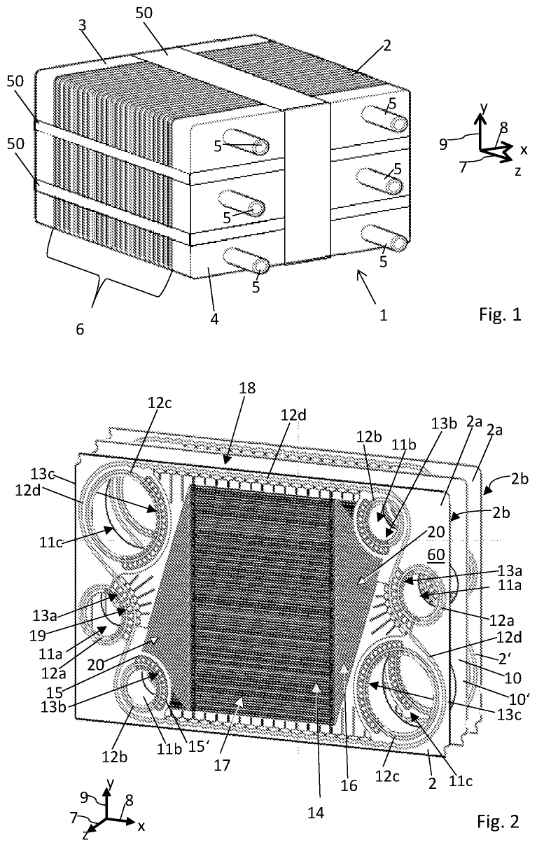

FIG. 1 shows an electrochemical system 1 comprising a plurality of structurally identical metal bipolar plates 2, which are arranged in a stack 6 and are stacked along a z-direction 7. The bipolar plates 2 of the stack 6 are clamped between two end plates 3, 4. Clamping may take place, for example, by way of straps 50 or tie-rods or tension plates (not shown). A closure mechanism of the straps may be arranged on the end plate 3 and is not visible in the view shown. The z-direction 7 is also referred to as the stacking direction. In the present example, the system 1 is a fuel cell stack. Each two adjacent bipolar plates 2 of the stack thus bound an electrochemical cell, which serves for example to convert chemical energy into electrical energy. To form the electrochemical cells of the system 1, a membrane electrode assembly (MEA) 10 is arranged in each case between adjacent bipolar plates 2 of the stack (see, for example, FIG. 2). Each MEA 10 typically contains at least one membrane, for example an electrolyte membrane. The MEA 10 often additionally comprises a frame-like reinforcing layer, which frames the electrolyte membrane and reinforces it in the region of overlap with the actual electrolyte membrane. The reinforcing layer is usually electrically insulating and prevents a short-circuit from occurring during operation of the electrochemical system 1.

In alternative embodiments, the system 1 may also be designed as an electrolyser, as an electrochemical compressor, or as a redox flow battery. Separator plates can also be used in these electrochemical systems. The structure of these separator plates may then correspond to the structure of the separator plates 2a, 2b of the bipolar plates 2 that are explained in detail here, although the media guided on and/or through the separator plates in the case of an electrolyser, an electrochemical compressor or a redox flow battery may differ in each case from the media used for a fuel cell system, and optionally just one separator plate—e.g. not a bipolar plate consisting of two separator plates—is installed between two membranes located closest to each other.

The z-axis 7, together with an x-axis 8 and a y-axis 9, spans a right-handed Cartesian coordinate system. The bipolar plates 2 each define a plate plane, each of the plate planes of the separator plates being oriented parallel to the x-y plane and thus perpendicular to the stacking direction or to the z-axis 7. The end plate 4 usually has a plurality of media ports 5, via which media can be supplied to the system 1 and via which media can be discharged from the system 1. Said media that can be supplied to the system 1 and discharged from the system 1 may comprise for example fuels such as molecular hydrogen or methanol, reaction gases such as air or oxygen, reaction products such as water vapour or depleted fuels, or coolants such as water and/or glycol.

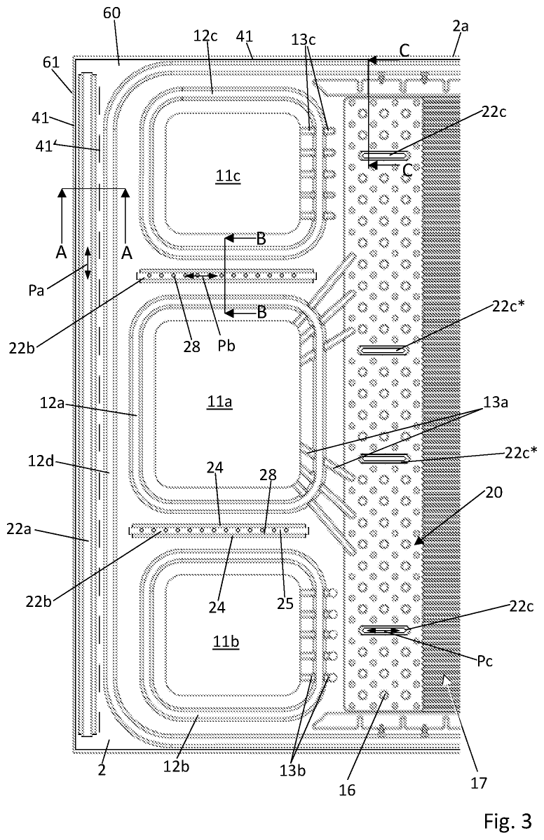

Both conventional bipolar plates 2, as shown in FIG. 2, and separator plates according to the present disclosure, or bipolar plates consisting thereof, as shown in FIG. 3 onwards, can be used in an electrochemical system as shown in FIG. 1.

FIG. 2 shows, in a perspective view, two adjacent bipolar plates 2, 2′, known from the prior art, of an electrochemical system of the same type as the system 1 from FIG. 1, as well as a membrane electrode assembly (MEA) 10 which is arranged between these adjacent bipolar plates 2 and is likewise known from the prior art, the MEA 10 in FIG. 2 being largely obscured by the bipolar plate 2 facing towards the viewer. The bipolar plate 2 is formed of two separator plates 2a. 2b which are joined together in a materially bonded manner (see also, for example, figure groups 4 to 6), of which only the first separator plate 2a facing towards the viewer is visible in FIG. 2, said first separator plate obscuring the second separator plate 2b. The separator plates 2a, 2b may each be manufactured from a metal sheet, for example from an optionally (pre-)coated stainless steel sheet. The separator plates 2a, 2b may for example be welded to each other along their outer edge, for example by laser-welded joints.

The separator plates 2a, 2b typically have through-openings, which are aligned with each other and form through-openings 11a-c of the bipolar plate 2. When a plurality of bipolar plates of the same type as the bipolar plate 2 are stacked, the through-openings 11a-c form lines which extend through the stack 6 in the stacking direction 7 (see FIG. 1). Typically, each of the lines formed by the through-openings 11a-c is fluidically connected to one of the media ports 5 in the end plate 4 of the system 1. For example, coolant can be introduced into the stack 6 via the lines formed by the through-openings 11a, while the coolant is discharged from the stack 6 via other through-openings 11a. In contrast, the lines formed by the through-openings 11b, 11c may be designed to supply fuel and reaction gas to the electrochemical cells of the fuel cell stack 6 of the system 1 and to discharge the reaction products from the stack 6. The media-guiding through-openings 11a-c are substantially parallel to the plate plane.

In order to seal off the through-openings 11a-c with respect to the interior of the stack 6 and with respect to the surrounding environment, the first separator plates 2a may each have sealing arrangements in the form of port beads 12a-c, which are arranged in each case around the through-openings 11a-c and in each case completely surround the through-openings 11a-c. On the rear side of the bipolar plate 2, facing away from the viewer of FIG. 2, the second separator plates 2b have corresponding port beads for sealing off the through-openings 11a-c (not shown). In cross-section, each bead arrangement of a port bead 12a-12d may have at least one bead top and two bead flanks, but a substantially angular arrangement between these elements is not necessary; a curved transition may also be provided, e.g. beads which are arcuate in cross-section are also possible.

Adjacent to an electrochemically active region 18 of the MEA, the first separator plates 2a have, on the front side thereof facing towards the viewer of FIG. 2, a flow field 17 with first structures 14 for guiding a reaction medium along the outer side (or also front side) of the separator plate 2a. In FIG. 2, these first structures 14 are defined by a plurality of webs and by channels extending between the webs and delimited by the webs. On the front side of the bipolar plates 2, facing towards the viewer of FIG. 2, the first separator plate 2a additionally has a distribution and collection region 20. The distribution and collection regions 20 comprise second structures 16 for guiding a reaction medium along the outer side (or also front side) of the separator plate 2a, these second structures being designed to distribute over the flow field 17 and thus over the active region 18 a medium that is introduced from a first of the two through-openings 11b into the adjacent distribution region 20 and to collect or to pool via the collection region 20 a medium flowing towards the second of the through-openings 11b from the flow region 17. In FIG. 2, the second structures 16, e.g. the structures of the distribution and collection region 20, are likewise defined by webs and by channels extending between the webs and delimited by the webs.

The port beads 12a-12c are crossed by conveying channels 13a-13c, which are in each case integrally formed in all the separator plates 2a, 2b, and of which the conveying channels 13a both on the underside of the upper separator plate 2a and on the upper side of the lower separator plate 2b form a connection between the through-opening 11a and the distribution region 20. By way of example, the conveying channels 13a enable coolant to pass between the through-opening 11a and the distribution and collection region 20, so that the coolant enters the distribution and collection region 20 between the separator plates 2a, 2b and is guided out therefrom.

The conveying channels 13b in the upper separator plate 2a and the conveying channels 13c in the lower separator plate 2b establish, together with apertures 15′ in the flanks of a connecting channel 15 connecting all the conveying channels 13b and 13c, a corresponding connection between the through-opening 11b or 11c and the respectively adjacent distribution or collection region 20. The conveying channels 13b thus enable hydrogen to pass between the through-openings 12b and the adjacent distribution or collection region on the upper side of the upper separator plate 2a. These conveying channels 13b adjoin apertures 15′—here in the flanks of the connecting channel 15—which face towards the distribution or collection region and which extend at an angle to the plate plane, through which apertures the hydrogen can flow. Conveying channels 13c, together with apertures 15′ in the flanks of the connecting channel 15, enable air, for example, to pass between the through-opening 12c and the distribution or collection region on the rear side of the bipolar plate 2, so that air enters the distribution or collection region on the underside of the lower separator plate 2b and is guided out therefrom (not visible in FIG. 2). Possible further embodiments are disclosed, for example, in the above-mentioned documents DE 20 2022 101 861, DE 20 2015 104 972, DE 20 2015 104 973 and DE 102 48 531 A1.

The first separator plates 2a each also have a further sealing arrangement in the form of a perimeter bead 12d, which extends around the flow field 17 of the active region 18 and also around the distribution or collection regions 20 and the through-openings 11b, 11c and seals these off with respect to the environment surrounding the system 1 and, together with the port beads 12a, with respect to the through-openings 11a, e.g. with respect to the coolant circuit. The second separator plates 2b each comprise corresponding perimeter beads 12d. The structures of the flow region 17, the distributing or collecting structures of the distribution or collection region 20 and the sealing beads 12a-d are each formed in one piece with the separator plates 2a and are integrally formed in the separator plates 2a, for example in an embossing, hydroforming or deep-drawing process. The same applies to the corresponding flow fields, distributing structures and sealing beads of the second individual plates 2b.

While the port beads 12a-12c have a substantially round course, which nevertheless depends primarily on the shape of the associated through-opening 11a-11c, the perimeter bead 12d has various portions that are shaped differently. For instance, the course of the perimeter bead 12d may include at least two wavy portions, and the port beads 12a-12c may also extend at least in part in a wavy manner.

As mentioned above, the present disclosure has been designed to protect separator plates compressed in a stack, and for example, the sealing beads 12a-12d thereof, against permanent deformation in the event of a crash. For this purpose, additional structures—namely load relief beads—are provided, which make it possible to absorb the impact energy. In the subsequent FIGS. 3-9, the sealing beads are shown with a flat bead top, but this is not necessary, e.g. the scaling bead may also have a bead top that is arcuate in cross-section, as shown in DE 10 2009 012 730 A1 for the prior art and the respective upper separator plate.

FIG. 3 shows a plan view of part of a separator plate 2a, for an electrochemical system 1, as shown in FIG. 1, which forms the layer of a bipolar plate 2 that faces towards the viewer. As in FIG. 2, three through-openings 11a-11c for media are provided, which can be fluidically connected via conveying channels 13a-13c to the distribution or collection region 20, which in turn is fluidically connected to the flow field 17 located opposite the active region of the MEA (not shown). The through-openings 11a-11c are each sealed off from the outside individually by means of port beads 12a-12c, and together with the distribution and collection regions 20 and the flow field 17 by means of the perimeter bead 12d. The separator plate 2a of FIG. 3 differs from that of FIG. 2 on the one hand by different shapes of the through-openings 11a-11c, by a modified routing of the perimeter bead 12d, which here encloses all the through-openings 11a-11c, and by the nub-like second structures 16 of the distribution or collection region 20. With regard to these elements, however, separator plates 2a according to the present disclosure, or the bipolar plate 2, may also be designed as shown in FIG. 2.

On the other hand, the separator plate 2a of FIG. 3 and the separator plate 2a of FIG. 2 differ by the additional load relief beads 22a-c, 22c*, which are shown only in the inventive embodiment of FIG. 3 and serve to relieve the load on the sealing beads 12a-d for example in a crash situation or in the event of an impact.

The load relief bead 22a extends along at least a portion of the perimeter bead 12d, at a small distance therefrom. It is therefore arranged between an outer edge 61, which delimits an outer circumference of the separator plate 2a, and the sealing bead 12d, here the perimeter bead, in a border region of the separator plate. Only in the corner regions does the load relief bead 22a move away from the perimeter bead 12d and terminate. In the other regions, the load relief bead 22a extends parallel to the perimeter bead 12d. The load relief beads 22b are arranged between the through-openings 11a and 11c and between the through-openings 11a and 11b and extend at a distance from and along at least a portion of the port beads 12a and 12c or 12a and 12b, e.g. between these port beads. Here, too, the sealing beads 12a-c and the load relief beads 22b extend in a parallel manner apart from in the corner regions of the port beads 12a-c and the end portions of the load relief beads 22b. The distance between the port beads 12a and 12c or 12a and 12b and the load relief bead 22b respectively extending therebetween is slightly greater than the distance between the perimeter bead 12d and the load relief bead 22a, and between the portions extending in a parallel manner corresponds approximately to the width of the load relief bead 22b or the port beads 12a-c. In comparison to the load relief bead 22a, the load relief beads 22b have a bead top 25 which extends between the bead flanks 24, the bead top being in part planar and having depressions 28 arranged at equal intervals along the entire extent.

Further load relief beads 22c, 22c* are arranged in the distribution or collection region 20. They extend between the second structures 16 and compared to the load relief beads 22a and 22b are at a much greater distance from the sealing beads 12a-d. While the load relief beads 22c extend in the extension of the conveying channels 13b, 13c and thus substantially parallel to the direction of flow of the medium in its respective flow plane (cf. FIG. 2), the load relief beads 22c* are arranged at an angle of almost 30° to the nearest conveying channels 13a.

The arrows Pa, Pb, Pc in FIG. 3 respectively show the direction of extension of the load relief bead 22a, 22b and 22c.

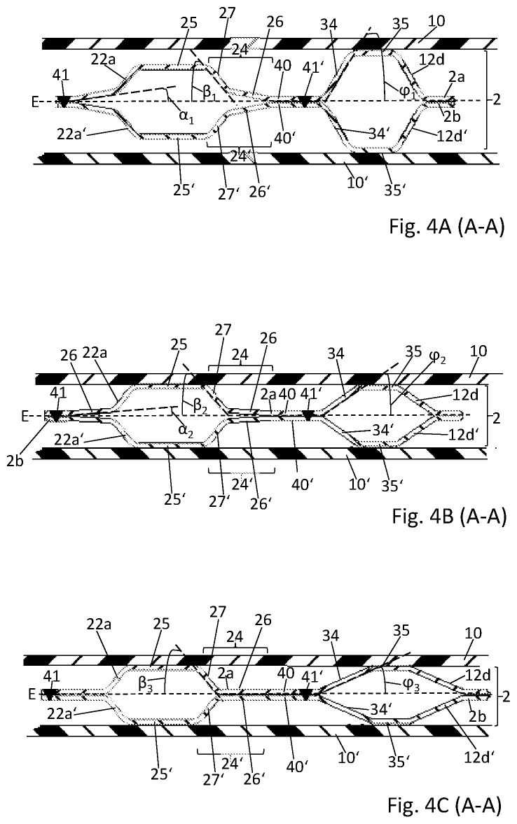

The sectional views of FIGS. 4A-4C, 5A-5D and 6A-6C respectively show a cross-section perpendicular to the course of the load relief bead 22a, 22b and 22c. Each of FIGS. 4A-4C, 5A-5D and 6A-6C shows a bipolar plate 2 comprising two separator plates 2a, 2b, which are connected to each other and are arranged in such a way that the undersides thereof face towards each other and the sealing beads 12, 12′ and load relief beads 22, 22′ of the two separator plates 2a, 2b point with their bead tops 25, 25′ and 35, 35′ away from each other. In the part shown, the separator plates 2a, 2b are symmetrical to each other and in their undeformed regions 40 bear against each other in the respective separator plate plane E. A description of the elements of the second separator plate 2b, which are denoted by a “ ” compared to those of the first separator plate 2a, will largely be omitted since, in the part shown, they could be converted into those of the separator plate 2a by reflection at the separator plate plane E. Similarly, in the case of arrangements that are otherwise symmetrical, usually just one element that can be converted into an analogous element by reflection is provided with a reference sign. All the beads and cross-sections are shown without a coating. They may in fact be entirely uncoated, but they may also be coated in full or in part on at least one of their surfaces, for example on the surface facing towards the MEA. For instance, the bead tops may be coated with a polymer-based coating, such as an elastomer-based coating. The MEA is also shown without any coatings and without any sealing elements of its own, but it could also have a coating and/or an elastomer-based sealing element, for example located opposite the bead tops and bearing against the latter.

FIGS. 4A to 4C each show a section through the bipolar plate 2 from FIG. 3 along the section line A-A, e.g. adjacent to the outer edge 61 of the bipolar plate 2. FIG. 4A shows the non-compressed state, FIG. 4B shows the compressed state as occurs under operating conditions, and FIG. 4C shows an overcompressed state in which the compression is greater than under normal operating conditions. The two separator plates 2a, 2b of the bipolar plate 2 are connected to each other by means of a continuous laser-welded joint 41 between the load relief bead 22a and then the sealing bead 12d at one side and the outer edge 61 at the other side, as well as by an interrupted laser-welded joint 41′ in a region between the sealing bead 12d and the load relief bead 22a.

Here, the sealing bead 12d is a symmetrical full bead 12d having a bead top 35 and bead flanks 34 and serves as a perimeter bead, e.g. for sealing off with respect to the surrounding environment. The load relief bead 22a is likewise symmetrical, but the bead flanks thereof each have a first, outer portion 26 and a second, inner portion 27 which are at different positive angles α, β to the separator plate plane E, said angles being clearly visible and distinguishable from each other as α₁, β₁ such as in FIG. 4A, e.g. in the non-compressed state. In the non-compressed state, the flank angle α₁ of the first, outer portion is approximately 10°, while the flank angle β₁ of the second, inner portion is approximately 50°. Therefore, in the non-compressed state, the flank angle α₁ of the first, outer portion 26 of the load relief bead 22a is smaller than the flank angle β₁ of the second, inner portion 27. However, in the non-compressed state of the separator plate 2a or the bipolar plate 2, the flank angle φ₁ of the sealing bead 12d is even steeper; it is approximately 60°. Therefore, in a cross-section perpendicular to the bead course at least in this non-compressed state of the separator plate, the at least one bead flank of the sealing bead has at least a third portion which is at a third positive angle φ to the separator plate plane, wherein the third angle φ1 is different from at least one of the flank angles of the load relief bead 22a, namely the first angle α₁ and/or the second angle β₁. In the example of FIG. 4A, the following applies for the non-compressed state: α₁<φ₁ and β₁<φ₁.

In this non-compressed state, in which the bipolar plates 2 can be stacked for example in a manner alternating with the membrane electrode assemblies 10, 10′ without external compression, only the sealing beads 12d, 12d′ bear against the adjacent MEAs 10, 10′. Therefore, in this non-compressed state, the height of the sealing bead 12d is greater than the height of the load relief bead 22a, e.g. the load relief bead 22a of the separator plate 2a projects less far out of the separator plate plane E than the sealing bead 12d.

In the compressed state, which is shown in FIG. 4B and corresponds to the operating state, both the sealing bead 12d with its bead top 35 and the load relief bead 22a with its bead top 25 come to bear against the MEA 10 or the reinforcing edge thereof. The load relief bead 22a therefore projects equally as far out of the separator plate plane as the sealing bead 12d. Both beads, e.g. the sealing bead 12d and the load relief bead 22a, thus undergo compression. Here, too, the flank angle α of the first, outer portion 26 of the load relief bead 22a is smaller than the flank angle β of the second, inner portion 27. In this case, the flank angle α₂ of approximately 6° is still slightly more than half of the flank angle α₁ of the non-compressed state. In contrast, the flank angle β₂ is identical to the flank angle β₁ of the non-compressed state. It is therefore greater than the flank angle φ₂ of the sealing bead, which has been reduced to approximately 35°. The following therefore also applies for the operating state: α₂<φ₂. In this compressed state of the separator plate 2a or the bipolar plate 2, the bead flank 34 of the sealing bead 12d is at an angle φ₂ to the separator plate plane E which is smaller than the flank angle β₂ of the second, inner portion 27 of the bead flank 24 of the load relief bead 22a.

In the state shown in FIG. 4C, which is an overcompressed state in which the separator plate 2a or the bipolar plate 2 undergoes greater compression than is the case under normal operating conditions, the first, outer portion 26 of the bead flank 24 of the load relief bead 22a is substantially fully compressed. It may extend in the separator plate plane E, as shown here, but it may also be slightly wavy around the latter. In this case too, therefore, the flank angle α of the first, outer portion 26 of the load relief bead 22a is smaller than the flank angle β of the second, inner portion 27. Compressed to 50°, the flank angle β3 of the second, inner portion 27 of the bead flank 24 of the load relief bead 22a has undergone a similar compression to the bead flank 34 of the sealing bead 12d, which spans an angle φ3 of approximately 27° to the separator plate plane E. In this compressed state too, therefore, the angle φ3 of the bead flank 34 of the sealing bead 12d is smaller than the flank angle β3 of the second, inner portion 27 of the bead flank 24 of the load relief bead 22a.

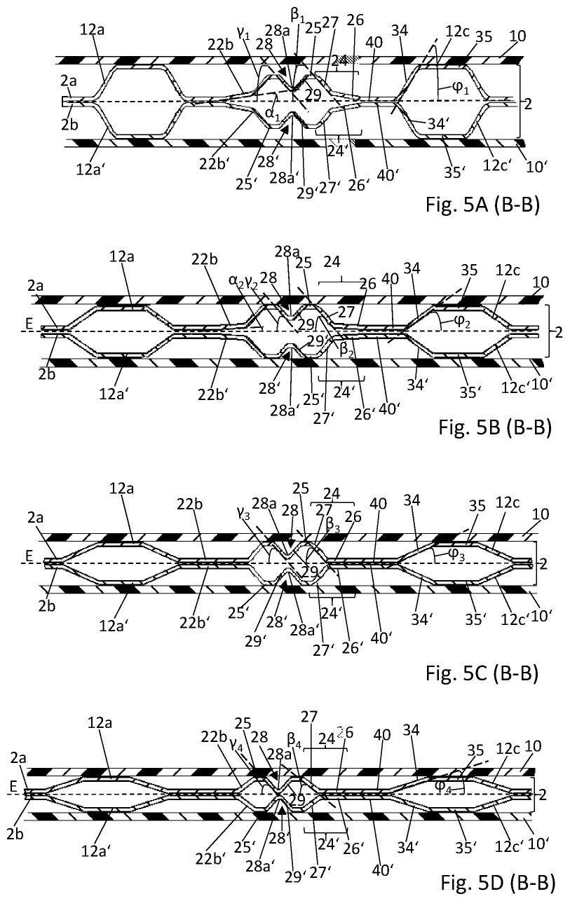

FIGS. 5A to 5D each show a section through the bipolar plate 2 from FIG. 3 along the section line B-B, e.g. between two through-openings 11a, 11c of the bipolar plate 2. Here, the sealing beads 12a, 12c are thus port beads for sealing off a through-opening 11a, 11c formed in the separator plate. Here, a respective sealing bead 12a or 12c is thus arranged on each side of the load relief bead 22b. FIGS. 5A to 5D each show a cross-section perpendicular to the course of the load relief bead 22b. FIG. 5A shows the non-compressed state, FIG. 5B shows the compressed state in the working range, and FIGS. 5C and 5D each show an overcompressed state in which the compression is greater than under normal operating conditions.

Here, the load relief bead 22b is sectioned at a location at which the bead top 25 has a depression 28. Between such portions, the bead top 25 is substantially planar. Instead of spot-shaped depressions, depressions which extend in the longitudinal direction Pb of the load relief bead would also be possible. The depression 28 has a bottom region 28a and flanks 29 with a flank angle γ.

In the non-compressed state of FIG. 5A, the angles α₁, β₁ and φ₁ are formed in a similar way as in FIG. 4A, e.g. α₁<β₁<φ₁. The flank angle γ₁ of the flank 29 of the depression 28 substantially corresponds to the angle β₁ that the second, inner portion 27 of the bead flank of the load relief bead 22b spans with the separator plate plane E. The bottom regions 28a, 28a′ of the depressions 28, 28′ are spaced apart from each other.

In the operating state shown in FIG. 5B, the ratios have changed in a manner substantially analogous to the compression from the non-compressed state into the working range, e.g. the transition from FIG. 4A to FIG. 4B. Furthermore, the flank angles of the flank 28 and of the flank section 27, γ₂ and β₂, are comparable, the bottom regions 28a, 28a′ of the depressions 28, 28′ have moved only minimally closer to each other and are still clearly spaced apart from each other.

In a first state compressed beyond the working range, as shown in FIG. 5C, the angle α can no longer be seen. The first, outer portion 26 of the bead flank 24 and the region 40 can no longer be distinguished from each other. As in the state shown in FIG. 4C, the second, inner portion 27 of the bead flank 24—together with the flank 29 of the depression 28—is the steepest portion in the illustrated part of the bipolar plate 2. The flank angle β₃ of this portion is now greater than the flank angle φ3 of the bead flank of the sealing bead 12c. Furthermore, the flank angles of the flank 28 and of the flank portion 27, γ₃ and β₃, are comparable, but the bottom regions 28a, 28a′ of the depressions 28, 28′ have now moved considerably closer to each other, but have not yet come to bear against each other.

When even higher forces are introduced, these are almost completely absorbed by the load relief bead 22b. The flank angle β₄ is reduced to approximately 40° in FIG. 5D, whereas it is approximately 50° in FIG. 5A, e.g. in the non-compressed state (β₁), and in FIG. 5B, e.g. in the working range (β₂). In contrast, the flank angle γ₄ of the depression 28 is still approximately 50°. Due to the inclination of the second, inner portion of the flank angle of the load relief bead, the bottom regions 28a, 28a′ of the depressions 28, 28′ have come to bear against each other here; the depressions support the load relief bead against further deformation.

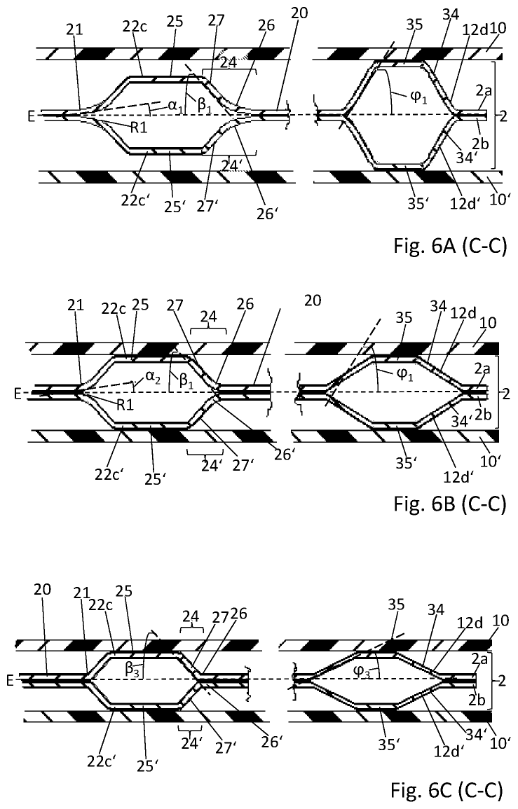

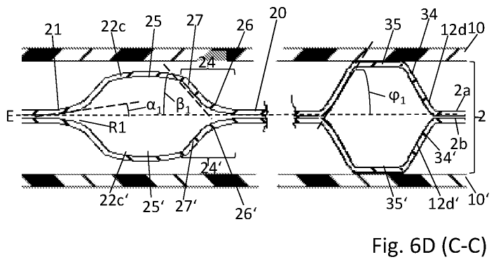

FIGS. 6A to 6C each show a section through the bipolar plate 2 from FIG. 3 along the section line C-C, which extends from the distribution region 20 to near the outer edge of the bipolar plate 2. However, the sections are shown in broken form, e.g. they each show only a cross-section perpendicular to the course of the load relief bead 22c and the sealing bead 12d, which is designed as a perimeter bead. FIG. 6A shows the non-compressed state, FIG. 6B shows the compressed state as occurs under operating conditions, and FIG. 6C shows an overcompressed state in which the compression is greater than in the working range.

In FIG. 6A, the perimeter bead 12d is shown in a different segment than in FIG. 4A, but is continued as such unchanged and thus has the same cross-section as in FIG. 4A. In contrast, the load relief bead 22c has a first portion 26 which extends from a bead foot 21 towards the bead top 25 at an increasing angle α. Specifically, in the cross-section shown, the first portion is curved with a radius R1, which here is 0.6 mm. In principle, the first portion 26 and/or the second portion 27 of the load relief bead 22c and/or the third portion, e.g. the bead flank 34, of the sealing bead 12d may extend in a rectilinear or curved manner in cross-section.

This radius R1 makes it possible for the angle at the bead foot 21 to hardly change during the transition from the non-compressed state (FIG. 6A) to the operating state (FIG. 6B). Rather, the first, outer portion 26 of the bead flank 24 of the load relief bead 22c rolls over this radius R1, and the region of this first, outer portion that is located further from the bead top 25 flattens out so that part of the first, outer portion extends in the separator plate plane E or merges with the latter, and the width of the bead flank 24, which visibly rises out of the separator plate plane E, decreases.

When compression beyond the working range occurs (FIG. 6C), it is no longer possible to distinguish the first, outer portion 26 of the bead flank 24 of the load relief bead 22c from portions of the separator plate 2a that extend adjacent to the separator plate plane E. Due to the compression of the separator plate 2a or the bipolar plate 2, the sealing bead 12d has undergone greater deformation than the second, inner portion 27 of the load relief bead 22c, so that the following also applies here: β₃>φ₃.

FIG. 6D shows an alternative variant of the bipolar plate shown in FIG. 6A, whereby the bead top 25 is curved slightly upwards, e.g. away from the plane of the separator plate. With the curved bead top, a maximum of 20%, and/or a maximum of 15% of the total bead height can be accounted for by the height of this curvature. Otherwise, the variant in FIG. 6D corresponds to the embodiment in FIG. 6A. During compression, the bead top 25 is pressed flat, sec FIGS. 6B and 6C, which show the separator plate 2 in a compressed or overcompressed state.

At least in the non-compressed state, often also in the compressed state, the first portion 26 and the second portion 27 of the bead flank 24 together form a convexly curved region in relation to the separator plate plane, whereas the second portion 27 and the bead top 25 together span a concavely shaped region in relation to the separator plate plane, see FIGS. 4A, 5A, 6A, 6D.

The flank portions, e.g. the first portion 26 and the second portion 27, and/or the bead top 25 can each be understood in cross-section as substantially straight line segments which are connected to each other, possibly via curved connecting portions. Sometimes the first angle α and the second angle β can be substantially constant, cf. FIGS. 4-6C.

For example, the flank angle α of the first, outer portion 26 in the non-compressed state may be 3°-30°, 4°-20°, and/or 4°-10°, while the flank angle β of the second, inner portion 27 in the non-compressed state can be between 45° and 85°, between 60° and 80° and/or between 70° and 80°.

For instance, the at least two flank portions 26, 27 take up a considerable proportion of the width of the entire load relief bead 22. For example, the entire flank, e.g. the first, outer portion 26 and the second, inner portion 27 together, can have a width which is more than 50%, more than 60%, more than 70% and/or more than 80% of the width of the bead roof 25. Summed over both bead flanks 24, their proportion of the total bead width is often more than half. For instance, the bead top 25 can act as a bearing area, usually a planar bearing area, for the MEA 10. If the width proportions of the at least two flank portions 26, 27 are considered separately, the width of the first, outer portion 26 may be at least ⅓, at least 40%, and/or at least 50% of the width of the bead top 25. The proportion of the width attributable to the second inner section 27 can be somewhat smaller; its width may be at least 20%, at least 25% and/or at least 30% of the width of the bead top 25.

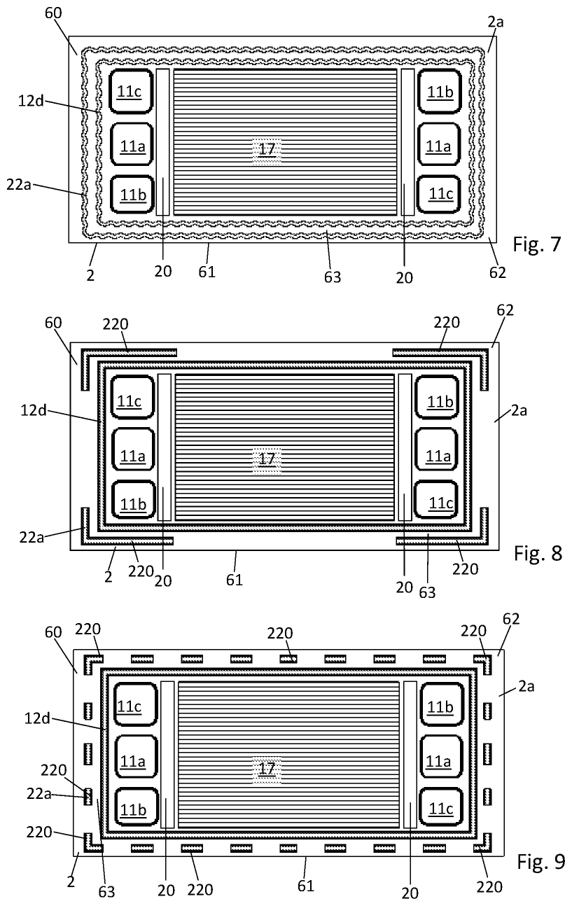

The load relief beads 22a, 22b, 22c may be used jointly in a separator plate as shown in FIG. 3, optionally with further load relief beads 22a, 22b, 22c, 22c*. However, it is also possible to use only load relief beads 22a and/or load relief beads 22b and/or load relief beads 22c in a separator plate 2a or bipolar plate 2. While the load relief bead 2a in FIG. 3 is designed in such a way that it extends in a rectilinear manner along its entire course, it may also extend in corner regions 62 of the separator plate and thus follow such a corner, as shown in FIGS. 7 to 9 in schematic plan views of separator plates 2a or bipolar plates 2. For the sake of clarity, port beads are not shown in the schematic FIGS. 7 to 9. In all three embodiments, in the regions 63 between the sealing bead 12d and the load relief bead 22a, the separator plate 2a extends in a substantially planar manner and/or parallel to the separator plate plane E and/or has no embossed structures.

In FIG. 7, the load relief bead is arranged between an outer edge 61, which delimits an outer circumference of the separator plate 2a, and the sealing bead 12d and extends all the way around, e.g. including in the corner regions 62 and border regions 60 of the separator plate 2a. In all regions, the load relief bead 22a extends substantially alongside the sealing bead 12d, mostly even parallel to the sealing bead 12d. Here, both the sealing bead 12d and the load relief bead 22a extend in a wavy manner with at least one wave period in their direction of extension. The waveforms of the sealing bead 12d and the load relief bead 22a are slightly offset from each other.

In contrast, in FIGS. 8 and 9, the load relief bead and the sealing bead extend in a rectilinear manner. In this case, the load relief bead 22a comprises a plurality of consecutive, spaced-apart load relief beads 220, which are arranged along the course of the sealing bead.

FIGS. 1-9 are shown approximately to scale. FIGS. 1-9 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” or “substantially” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A separator plate for an electrochemical system, the separator plate comprising:
a separator plate plane;
at least one sealing bead for sealing off a region of the separator plate,
at least one load relief bead which relieves load on the sealing bead, the load relief bead arranged spaced apart from the sealing bead, and, in a cross-section perpendicular to the course of the load relief bead, at least in a non-compressed state of the separator plate, at least one bead flank of the load relief bead comprises, in at least a first segment along the direction of extension, at least a first, outer portion and a second, inner portion which are at different positive angles to the separator plate plane.

2. The separator plate according to claim 1, wherein, in a compressed state of the separator plate, at least one bead flank of the sealing bead is at a smaller angle to the separator plate plane than the second inner portion of the bead flank of the load relief bead.

3. The separator plate according to claim 1, wherein, in the non-compressed state and/or in the compressed state, the first, outer portion is at a first angle α and the second, inner portion is at a second angle β, where α<β.

4. The separator plate according to claim 3, wherein, in a cross-section perpendicular to the bead course, at least in the non-compressed state of the separator plate, at least one bead flank of the sealing bead has at least a third portion which is at a third positive angle φ to the separator plate plane, wherein the third angle φ is different from the first angle α and/or from the second angle β.

5. The separator plate according to claim 4, wherein the following applies: α<φ.

6. The separator plate according to claim 1, wherein the sealing bead is a port bead for sealing off a through-opening formed in the separator plate or a perimeter bead for sealing off a flow field of the separator plate.

7. The separator plate according to claim 1, wherein the load relief bead is arranged between an outer edge, which delimits an outer circumference of the separator plate, and the sealing bead.

8. The separator plate according to claim 1, wherein the load relief bead is arranged adjacent to a port bead.

9. The separator plate according to claim 1, wherein the separator plate has at least two through-openings as well as distribution, flow and collection regions fluidically connected thereto, wherein at least one load relief bead is arranged in a distribution region or in a collection region.

10. The separator plate according to claim 1, wherein the at least one load relief bead comprises a plurality of consecutive, spaced-apart load relief beads which are arranged along the course of the sealing bead.

11. The separator plate according to claim 1, wherein, in one, some or all regions, the load relief bead and the sealing bead extend substantially alongside each other.

12. The separator plate according to claim 1, wherein, in the non-compressed state of the separator plate, the load relief bead projects equally as far or less far out of the separator plate plane than the sealing bead.

13. The separator plate according to claim 1, wherein, in the compressed state of the separator plate, the load relief bead projects equally as far out of the separator plate plane as the sealing bead.

14. The separator plate according to claim 1, wherein the load relief bead has a bead top which extends between the bead flanks, wherein the bead top is substantially planar or is curved away from the separator plate plane or has at least one depression in a portion of the load relief bead.

15. The separator plate according to claim 1, wherein the first portion and/or the second portion of the load relief bead and/or the third portion of the sealing bead extends in a rectilinear or curved manner in cross-section.

16. The separator plate according to claim 1, wherein the first portion extends from a bead foot towards the bead top at an increasing angle α in cross-section extends in a curved manner with a radius R1, where R1≤50 mm.

17. The separator plate according to claim 16, wherein in one, some or all of the portions in which the load relief bead and the sealing bead extend in a substantially parallel manner, the mutually facing bead flanks of the sealing bead and the load relief bead are at different positive angles to the separator plate plane in a cross-section perpendicular to the bead course.

18. The separator plate according to claim 1, wherein the sealing bead and/or the load relief bead extends in a wavy manner with at least one wave period in its direction of extension.

19. A bipolar plate comprising two separator plates according to claim 1, which are connected to each other and are arranged in such a way that the undersides thereof face towards each other and the sealing beads and load relief beads of the two separator plates point with their bead tops away from each other.

20. The bipolar plate according to claim 19, wherein the two separator plates are at least in part connected to each other by means of welded joints on both sides of the load relief bead and/or between the load relief bead and the sealing bead and/or on both sides of the sealing bead.

21. An electrochemical system comprising a plurality of separator plates according to claim 1 and/or a plurality of bipolar plates, which are stacked in a stack perpendicular to the separator plate planes.
